(19) United States
(12) Patent Application Publication
(10) Pub. No.: US 2003/0154443 A1
(43) Pub. Date: Aug. 14, 2003

(54) Visual discovery tool

(75) Inventors: Karen Papierniak, Fenton, MI (US); Paul Cereghini, Escondido, CA (US); Kavitha Devarakonda, Edison, NJ (US); Giai Do, San Diego, CA (US); Sreedhar Srikant, Marietta, GA (US); Eric Dunsker, Atlanta, GA (US)

Correspondence Address: JAMES M. STOVER, NCR CORPORATION, 1700 SOUTH PATTERSON BLVD, WHQ4, DAYTON, OH, 45479, US

(73) Assignee: NCR Corporation

(21) Appl. No.: 10/073,305

(22) Filed: Feb. 13, 2002

(51) Int. Cl. G06F 15/00

(52) U.S. Cl. 715/502

(57) ABSTRACT

A visual discovery tool for graph generation is described. The visual discovery tool has a database for storing a data set, rules, and graph types and a graph generator for selectively applying rules and graph types to the data set to generate graphs. In one embodiment, triggers and threshold values are stored in the database to determine the execution of the graph generator. In another embodiment, a user interface enables the customization of the rules and graph types.

### FIELD OF THE INVENTION

The present invention relates generally to web site visualization tools, and more particularly, to a web site visualization tool for business analysis. More specifically, the present invention relates to automating graph creation for a specific data set.

### BACKGROUND ART

Currently, web site data visualizations are created individually by a subject matter expert having access to a skilled visualization designer. The visualizations are dependent on the available data and the visualization or graphing tool being used. Typically, creating graphs is an iterative process and requires additional effort every time the data changes or graphs are refined. Therefore, there is a need in the art for a tool which analyzes data and suggests best-fit graphs. Further, there is a need in the art for such a tool which stores graph settings and best-fit rules and acts as an archive for future customizations.

Present day tools and documented processes exist to create visualizations, choose appropriate graphs, and monitor data; however, these products are neither integrated nor automated.

A list of existing products currently in use to create visualizations includes: Visual Insights Advizor, SPSS nVIZn SDK, Tom Sawyer's Graphic Editor Toolkit, Inxight Hyperbolic Tree SDK, Visual Mining NetChart, and Gigasoft, Inc. Pro Essentials.

The Visual Insights training materials contain a Design Workshop document which describes how to manually select a graph in order to answer a specific question about the data. Other products are designed to monitor data warehouses, e.g., NCR Corporation's Teradata Active Warehouse. However, the inventors are unaware of a product generating visualizations based on changes in the data or other sources using best-fit rules.

### DISCLOSURE/SUMMARY OF THE INVENTION

It is therefore an object of the present invention to provide a tool for analyzing data and generating best-fit graphs.

Another object of the present invention is to provide a tool which stores graph settings and best-fit rules.

Still another object of the present invention is to provide a tool which acts as an archive for future customizations of graph settings and best-fit rules.

The above described objects are fulfilled by a method of analyzing data and generating best-fit graphs using a visual discovery tool. The visual discovery tool automatically generates graphs for data sets. A data set is selected and one or more rules are applied to the data set. At least one graph based on the data set and rule applied is generated and selectively published. Advantageously, the tool applies rules to analyze the data set and generate the appropriate or best-fit graph automatically. Further, the graph settings and best-fit rules are able to be customized and stored with the tool as well as archived for future use and customization.

In an apparatus aspect, the visual discovery tool is a system for automatic graph generation from data sets. The system includes a database storing a data set, at least one rule, and at least one graph type and a graph generator selectively applying at least one rule and graph type to the data set to generate at least one graph.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level functional diagram of a computer system useable with an embodiment of the present invention;

FIG. 2 is a high level functional flow diagram of a use of an embodiment of the present invention;

FIG. 3 is a high level functional block diagram of an embodiment of the present invention;

FIG. 4 is a sample user interface for graph selection of an embodiment of the present invention; and

FIG. 5 is a sample user interface for rule customization of an embodiment of the present invention.

### BEST MODE FOR CARRYING OUT THE INVENTION

A method and apparatus for data visualization, i.e., data analysis and best-fit graph suggestion, are described. In the following description, for purposes of explanation, numerous specific details are set forth in order to provide a thorough understanding of the present invention. It will be apparent; however, that the present invention may be practiced without these specific details. In other instances, well-known structures and devices are shown in block diagram form in order to avoid unnecessarily obscuring the present invention.

Hardware Overview

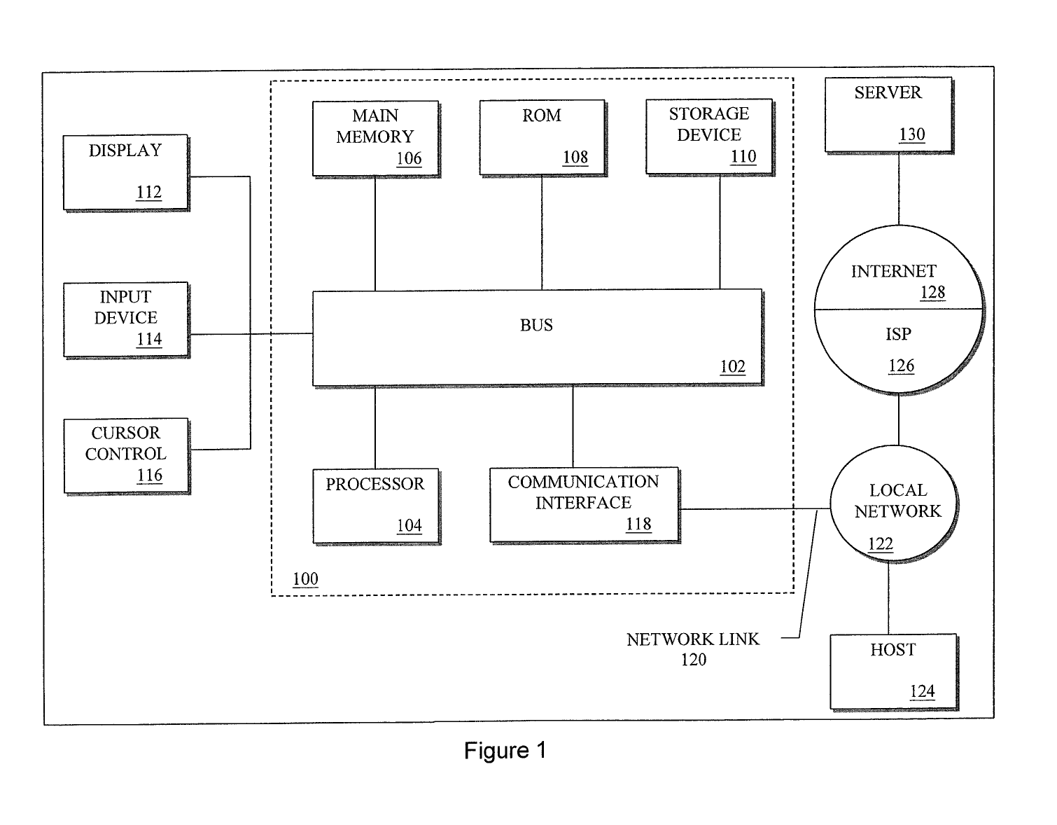

FIG. 1 is a block diagram illustrating an exemplary computer system 100 upon which an embodiment of the invention may be implemented. The present invention is usable with currently available personal computers, mini-mainframes and the like.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing information and instructions to be executed by processor 104. Main memory 106 also may be used for storing rules, graphs, thresholds, triggers, and databases (described in detail below), and temporary variables or other intermediate information during execution of instructions to be executed by processor 104. Computer system 100 further includes a read only memory (ROM) 108 or other static storage device coupled to the bus 102 for storing static information and instructions for the processor 104, including the rules, graphs, thresholds, triggers, and databases described below. A storage device 110, such as a magnetic disk or optical disk, is provided and coupled to the bus 102 for storing information and instructions.

Computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Another type of user input device is cursor control 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

The invention is related to the use of a computer system 100, such as the illustrated system, to provide a visual discovery tool. According to one embodiment of the invention, a visual discovery tool is provided by computer system 100 in response to processor 104 executing sequences of instructions contained in main memory 106 to display graphs for business analysis. Such instructions may be read into main memory 106 from another computer-readable medium, such as storage device 110. However, the computer-readable medium is not limited to devices such as storage device 110. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides a two-way data communication as is known. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals which carry digital data streams representing various types of information. Although not required for operation of the present invention, the communications through interface 118 may permit transmission or receipt of the visual discovery tool or access to the data needed by the visual discovery tool. For example, two or more computer systems 100 may be networked together in a conventional manner with each using the communication interface 118.

Network link 110 typically provides data communication through one or more networks to other data devices. For example, network link 110 may provide a connection through local network 122 to a host computer 124 or to data equipment operated by an Internet Service Provider (ISP) 126. ISP 126 in turn provides data communication services through the world wide packet data communication services through the world wide packet data communication network now commonly referred to as the “Internet” 128. Local network 122 and Internet 128 both use electrical, electromagnetic or optical signals which carry digital data streams. The signals through the various networks and the signals on network link 110 and through communication interface 118, which carry the digital data to and from computer system 100, are exemplary forms of carrier waves transporting the information.

Computer system 100 can send messages and receive data, including program code, through the network(s), network link 110 and communication interface 118. In the Internet example, a server 130 might transmit a requested code for an application program through Internet 128, ISP 126, local network 122 and communication interface 118. In accordance with the invention, one such downloaded application provides for a visual discovery tool, as described herein.

The received code may be executed by processor 104 as it is received, and/or stored in storage device 110, or other non-volatile storage for later execution. In this manner, computer system 100 may obtain application code in the form of a carrier wave.

Top Level Description

A Visual Discovery Tool (VDT) is used in conjunction with the Visualization Tool for Web Analytics (VTWA), which is described in a copending application (Docket No. 3225-123, not yet filed) commonly assigned and hereby incorporated by reference in its entirety, to automate the process of creating graphs for a specific data set. The VDT provides the graphs for the graphical presentation used in the VTWA or suggests new graphs. The VDT is used to find patterns and exceptions in the data by automatically generating the appropriate graphs and distributing the graphs to business analysts using the VTWA.

### DETAILED DESCRIPTION

Functional

The visual discovery tool (VDT) is a tool used to automate the process of creating graphs for a specific data set. Through the use of data, e.g., from one or more data warehouses or decision support systems, and a standard set of graphs as input to the rules based engine, the VDT generates best fit graphs.

Through the use of the VDT, a power user or administrator is able to select one or more graphs and establish a relationship between graphs. Graphs selected by an administrator are generated automatically when the data reaches a set threshold and may then be referenced and used by business analysts. Professional service personnel are able to customize standard graphs, filters, thresholds, and best fit rules.

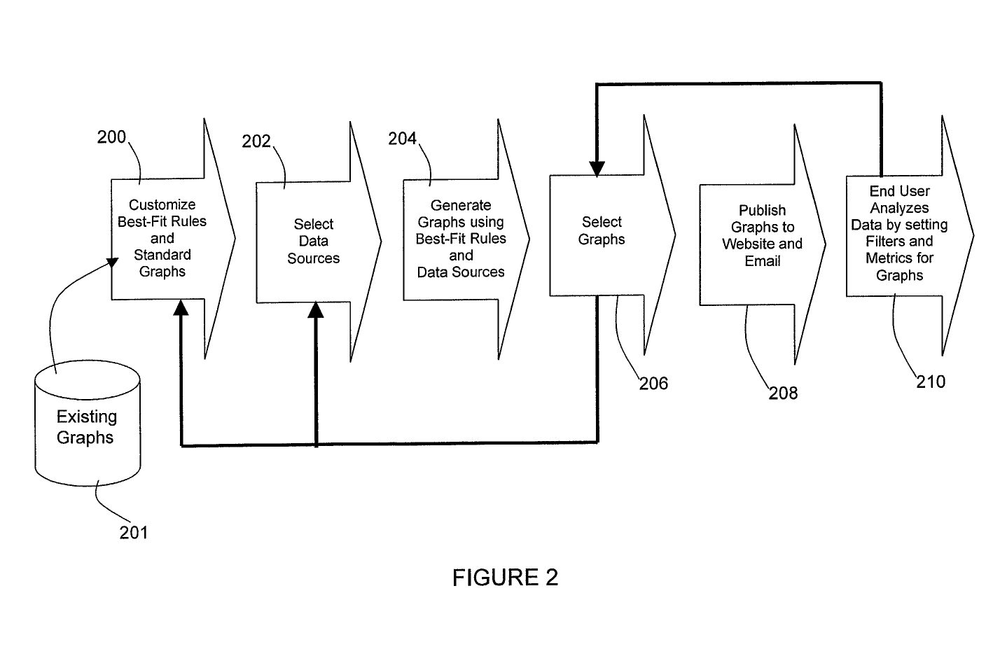

FIG. 2 is a diagram of the functional flow of use of the visual discovery tool and the iterative process of selecting graphs and data sources.

As shown in the diagram of FIG. 2, the process begins at step 200 wherein the best fit rules and standard or existing graphs, i.e., existing graphs 201, are customized by professional service personnel. After the rules and graphs have been customized in step 200 the flow proceeds to step 202 where the data sources are selected by an administrator.

After data source selection in step 202, the flow proceeds to step 204 wherein the visual discovery tool generates graphs using the best fit rules and selected data sources as input. Upon graph generation in step 204, the flow proceeds to step 206 wherein an administrator or analyst selects graphs.

After graph selection in step 206, the flow may proceed to step 208, or return to either step 200, e.g. for additional rules and graphs customization, or step 202, e.g. for additional or different data source selection. In step 208, an administrator is able to publish graphs to a web site, for example, establish links to Online Analytical Processing (OLAP) reports, and/or transmit graphs via e-mail. The flow then proceeds to step 210 wherein an end user or business analyst analyzes the data by setting filters and metrics for graphs.

The flow may then proceed to provide the graphs as input to the visualizations tool for Web analytics or the flow returns to step 206 for modification of graph selection.

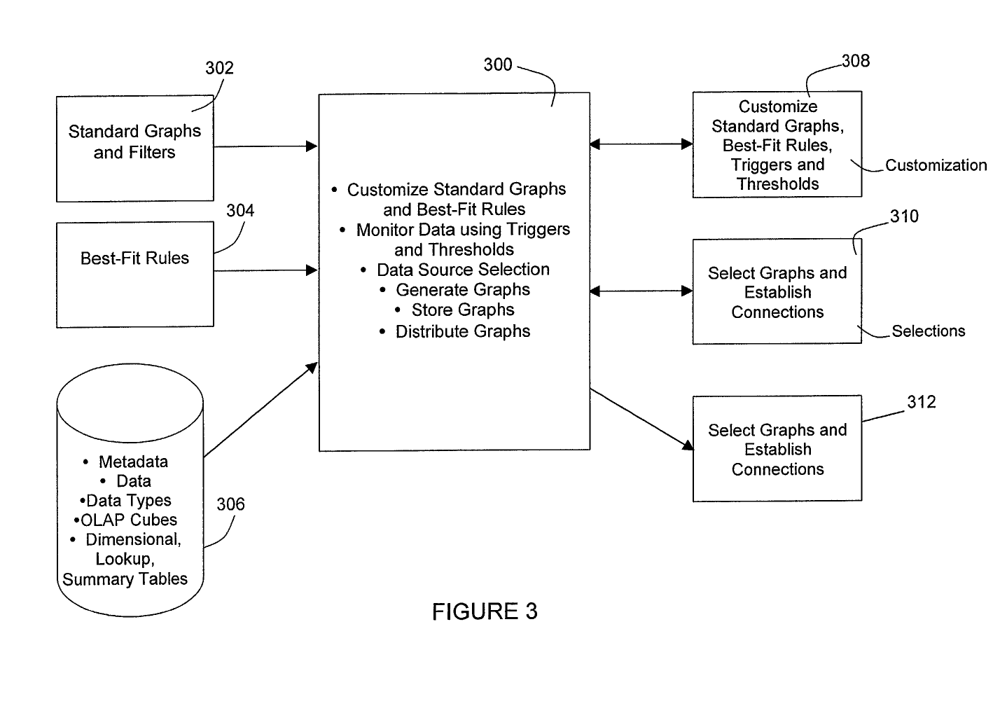

FIG. 3 is a diagram showing a high level functional block diagram of the architecture of the visual discovery tool.

With respect to FIG. 3, visual discovery tool 300 receives input from standard graphs and filters repository 302, best fit rules repository 304, and data warehouse or database 306. VDT 300 accesses, i.e. reads and writes, customization repository 308 and selections repository 310. Graphs 312 are provided as output from VDT 300.

VDT 300 includes functionality enabling customization of standard graphs and best fit rules, monitoring of data using triggers and thresholds, selecting data sources, and generating, storing, and distributing graphs. Standard graphs and filters from standard graphs and filters 302 used as input to VDT 300 and customization of the graphs and filters is stored in customization repository 308. In the same matter, best fit rules from best fit rules repository 304 are received as input to VDT 300 and customized and stored for later access and used by VDT 300 in customization repository 308. Database 306 is the data source used in graphs generation by VDT 300. Graphs elections and connections established between data from database 306 and graphs from either standard graphs and filters repository 302 or customization repository 308 are stored in selections repository 310.

After a trigger and/or threshold is satisfied by data in database 306, one or more best fit rules is applied to the data and one or more graphs are generated by VDT 300. Triggers and thresholds are described in detail below.

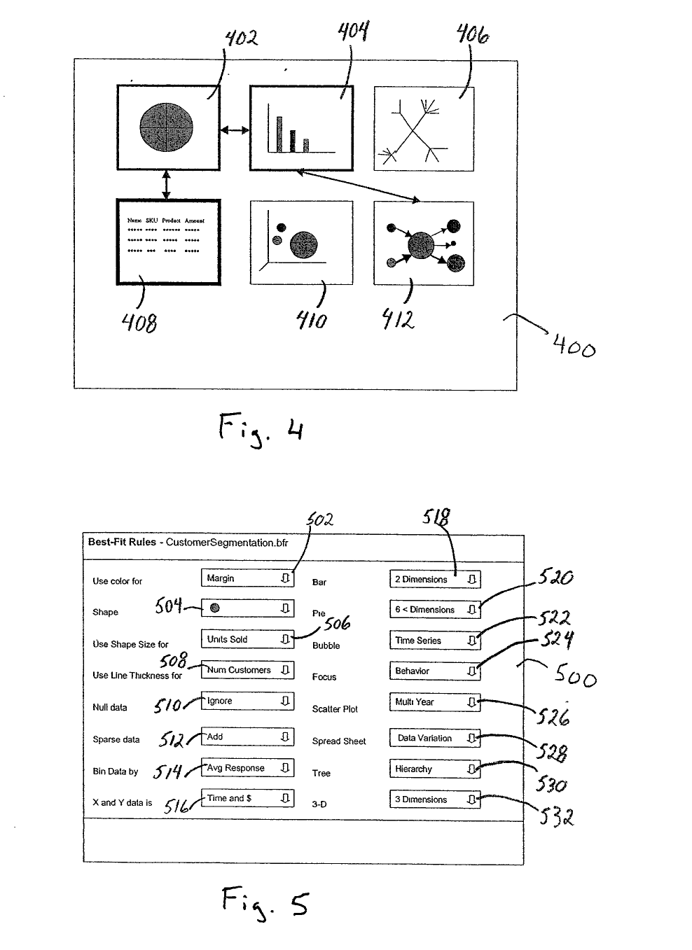

Standard graphs and filters repository 302 includes many different types of graphs, e.g. pie, tree, bar, or scatter, several of which are shown and described in conjunction with FIG. 4 below. An administrator or professional service personnel can customize the graphs and store them for later use in customization repository 308.

FIG. 4 is an example user interface used for graph selection. User interface 400 includes a number of graphs representing possible graphs for selection by an administrator. The graphs include pie charts 402, bar chart 404, tree chart 406, spreadsheet chart 408, scatter chart 410, and relationship chart 412.

Graphs 402, 404, and 408 have thick borders surrounding them indicating that these individual graphs will appear together in a single output graph, as stored in graphs 312. The arrows connecting graphs 402, 404, 408, and 412 indicate that each graph is generated by VDT 300 using the same data from database 306.

As described above, graph selections, e.g. the selections as shown in user interface 400 of FIG. 4, are stored in selections 310.

A description of customizing rules from best fit rules repository 304 is now provided. A sample user interface for customizing best fit rules is shown in FIG. 5. Rule customization interface 500 is used to specify default values used for generating graphs based on data from database 306. The rule customization interface 500 has numerous drop down menus enabling the user to specify default values for rules. The menus include a color menu 502, a shape menu 504, a shape size menu 506, a line thickness menu 508, and null data menu 510, a sparse data menu 512, a bin data menu 514, an X and Y menu 516, a bar menu 518, a pie menu 520, a bubble menu 522, a focus menu 524, a scatter plot menu 526, a spread sheet menu 528, a tree menu 530, and a 3-D menu 532. Default values for each of the menus 502-532 are based on the data in database 306, e.g. the number of dimensions, the range of the data values, if the data is time dependent, and if the data is hierarchical.

Color menu 502 specifies which portion of a graph will be colored. Shape menu 504 specifies the shape to be used in a graph and shape size menu 506 specifies the data for which a shape will be representative. Line thickness menu 508 specifies which data from database 306 will be represented by line thickness. Null data menu 510 and sparse data menu 512 specify how these particular types of data are to be used, or not used, in the graphs. Bin data menu 514 specifies by what parameter data is to be binned and X and Y menu 516 specifies the format for X and Y type data. Bar menu 518 specifies when a bar type graph is to be used, e.g. as shown in figure five, when data having two dimensions is selected a bar type graph will be generated. Similarly, pie menu 520 specifies that data having six or more dimensions will be graphed using a pie chart. Bubble menu 522 is used to specify a bubble shape for a particular series of data.

Focus menu 524 is used to specify the location or object on the graph to which the user's attention is to be directed and how and/or if the focus may be changed by a user. Focus menu 524 includes possible choices of a) behavior, wherein the user is able to modify the focus of a generated graph, b) fixed, wherein the focus cannot be changed by the user, and c) data-selected, wherein the focus is data driven, e.g., the largest value is in focus.

The scatter plot menu 526 specifies the data series to be plotted on scatter type graph. Spread sheet menu 528 is used to specify the data shown in a spread sheet type graph, e.g. spread sheet graph 408. Similarly, tree menu 530 and 3-D menu 532 are used to specify the data shown in a tree type graph and 3-D type graph, e.g. tree graph 406 and 3-D graph 410 of FIG. 4, respectively.

The best fit rules are based on a number of criteria of the data in database 306 including the number of dimensions, data sparsity, and the value of the data, e.g. percent null, zero, blank, range, and types.

The data in database 306 is used as input to VDT 300 and includes both analyzed and unanalyzed data, such as data, metadata from on-line analytical processing (OLAP), data mining, and portal tools, data types, data definition, OLAP cubes including dimensions, metrics, and filters, and dimensional, lookup, and summary tables.

The VDT 300 is primarily used to find patterns and exceptions to find patterns and exceptions in data and automatically generate appropriate graphs. The generated graphs are dynamic and change based on data changes, customization, or best fit rules.

Triggers and thresholds are used for monitoring data changes. For example, if a threshold is reached graphs are automatically generated and distributed, e.g. if more than 10 days of data are added to a data warehouse, best fit rules are applied to the data and a graph is automatically generated and distributed. A trigger includes exception events such as when the data indicates that the number of units sold is negative or when the number of units sold is less than ten percent of the stock. Both triggers and thresholds can cause the application of rules to data and the generation of a graph.

The VDT 300 may also be used to verify the output of other analytical tools, e.g. OLAP report validity may be verified. Reports from other analytical tools are supplied is employed to VDT 300 and graphs are generated to show exceptions or trends which may be hidden in spreadsheets or charts of the analytical tools.

In another embodiment, VDT 300 may be used as an Information portal combining data from multiple sources and graphically displaying the data. The generated graphs may contain links to OLAP reports, mining results, informational systems, and data feedback streams.

An example is helpful to understand the operation of the present invention. A user desiring to view graphs of a specific data set interacts with VDT 300 to specify the rules to be applied, the graphs to be generated, and to select the data to be graphed. During step 200, the user customizes a rule from best-fit rules repository 304 using rule customization interface 500. The user selects a different shape from shape menu 504 and specifies that null data will be ignored by selecting the ignore option from the null data menu 510. The customized rule is then stored in customization repository 308. Similarly, the user customizes a graph type using known tools (not shown) and stores the customized graph type to customization repository 308 or standard graph and filters 302.

Next, in step 202, the user selects a data source from database 306 to be graphed. Applying the rules from best-fit rules repository 304 and customized rules from customization repository 308, the VDT 300 in step 204 generates several graphs using the selected data source from database 306. The generated graphs from step 204 are displayed in graph selection interface 400 for user selection according to step 206. The user selects the generated graphs, e.g., pie chart 402, bar chart 404, and spreadsheet chart 408 as shown in FIG. 4. The user selected graphs are then published to a website in step 208, as specified by the user.

In step 210, the user or an anlyst analyzes the data presented in the generated graphs. The user may then decide to select different or additional graphs to be generated by returning the step 206.

Advantageously, the VDT 300 provides a tool for analyzing data and generating best-fit graphs and storing graph settings and best-fit rules. Further, the VDT acts as an archive for future customizations of graph settings and best-fit rules.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A method of automatically generating graphs for data sets, comprising the following steps:
selecting a data set;
applying a rule to the data set; and
generating at least one graph based on the data set and rule applied.

2. The method as claimed in claim 1, further comprising the step of selectively publishing at least one of the graphs generated.

3. The method as claimed in claim 1, further comprising the step of customizing a rule.

4. The method as claimed in claim 1, further comprising the step of customizing a graph type; and
wherein the graph generated by the generating step is based on the graph type.

5 The method as claimed in claim 2 wherein the publishing step includes publishing a graph to a website.

6. The method as claimed in claim 2, wherein the publishing step includes publishing a graph by transmitting the graph in connection with email.

7. The method as claimed in claim 2, wherein the publishing step includes publishing a graph by storing the graph to a storage device.

8. The method as claimed in claim 1, wherein the generating step occurs as a result of a trigger event.

9. The method as claimed in claim 1, wherein the generating step occurs as a result of a threshold being met or exceeded.

10. The method as claimed in claim 1, wherein the data set includes at least one of data, metadata, OLAP cubes, dimensional tables, lookup tables, and summary tables.

11. The method as claimed in claim 1, wherein the rule includes at least one of number of dimensions, data sparsity, and value of data as rule criteria.

12. The method as claimed in claim 4, wherein the graph type includes at least one of a pie chart, a bar chart, a tree graph, a spreadsheet chart, a scatter plot, and a 3-D graph.

13. A system for automatic graph generation from data sets, comprising:
a database storing a data set, at least one rule, and at least one graph type; and
a graph generator selectively applying at least one rule and graph type to the data set to generate at least one graph.

14 The system as claimed in claim 13, wherein the data set includes at least one of data, metadata, OLAP cubes, dimensional tables, lookup tables, and summary tables.

15. The system as claimed in claim 13, wherein the graph type includes at least one of a pie chart, a bar chart, a tree graph, a spreadsheet chart, a scatter plot, and a 3-D graph.

16. The system as claimed in claim 13, wherein the database further stores at least one trigger; and
wherein the graph generator selectively applies at least one rule and graph type to the data set to generate at least one graph as a result of a trigger event.

17. The system as claimed in claim 13, wherein the database further stores at least one threshold value; and
wherein the graph generator selectively applies at least one rule and graph type to the data set to generate at least one graph as a result of a threshold value being met or exceeded.

18. The system as claimed in claim 13, further comprising a user interface for customizing the rule.

19. The system as claimed in claim 13, further comprising a user interface for customizing the graph type.

20. The system as claimed in claim 13, wherein the graph generator publishes generated graphs.

21. The system as claimed in claim 20, wherein the graph generator publishes generated graphs to at least one of a website, email, and a storage device.
